(19) United States
(12) Patent Application Publication
(10) Pub. No.: US 2017/0161179 A1
(43) Pub. Date: Jun. 8, 2017

(54) SMART COMPUTER PROGRAM TEST DESIGN

(71) Applicant: International Business Machines Corporation, Armonk, NY (US)

(72) Inventors: Elizabeth J. Maple, Basingstoke (GB); Kevin B. Smith, Eastleigh (GB); David R. Waddling, Winchester (GB)

(21) Appl. No.: 14/956,700

(22) Filed: Dec. 2, 2015

(51) Int. Cl. G06F 11/36

(52) U.S. Cl. CPC G06F 11/3684; G06F 11/3664

(57) ABSTRACT

In an approach to selecting a set of test resources for testing a computer program including untested computer program code, one or more computer processors retrieve a time stamp for an untested computer program code, wherein the time stamp is indicative of a time of generation of the untested computer program code. The one or more computer processors calculate, based, at least in part, on the retrieved time stamp, an accuracy risk factor for the untested computer program code. The one or more computer processors select, based, at least in part, on the calculated accuracy risk factor, a set of one or more test resources from a pool of test resources.

### BACKGROUND OF THE INVENTION

Aspects of the present invention relate to methods, computer program products and computer systems that facilitate efficient testing of computer program code.

Computer programs, i.e., software, nowadays are routinely executed on a plethora of different types of computers or platforms, e.g., desktop computers, tablet computers, smart mobile devices such as smartphones, and the like, and many daily tasks rely upon the execution of such computer programs.

Consequently, it is imperative that such computer programs are reliable such that errors in the computer program code leading to erroneous behavior or even failure of the computer program can be avoided, as such erroneous behavior or failure is highly inconvenient and potentially dangerous, for example, where the computer program is intended to enforce certain safety measures.

To this end, computer programs are routinely tested using a suite of test programs, where tests may be performed across multiple platforms, in order to ensure that the computer program operates as intended or at least to ensure that the risk of erroneous behavior or failure is reduced and preferably minimized. This may apply to newly developed computer programs as well as to updated versions of existing computer programs, as, in both scenarios, the computer programs will comprise untested computer program code for which it is unknown if the code exhibits the desired execution behavior.

Testing computer programs, i.e., software, typically requires running a vast number of tests against the computer program code and often on multiple platforms (e.g., mobile phone handset hardware, operating systems, and the like, and combinations thereof). The number of tests that are available for software testing is typically such that it is not practically feasible, e.g., cost-effective, to test the untested computer program code using all tests across all platforms or to provide the hardware platforms that facilitate exhaustive testing of untested software across all platforms for which the software is to be rolled out every time a version of the software is to be built.

Consequently, the set of tests, i.e., the number of test programs, the number of platforms on which the software is to be tested, the number of repetitions of each test, and so on, to which the untested computer program code of the computer program on the test is to be exposed needs to be as efficient as possible without significantly compromising the accuracy or completeness of the test coverage of the set of tests to which the computer program on the test is to be exposed.

### SUMMARY

Embodiments of the present invention disclose a method, a computer program product, and a system for generating an efficient set of tests for a computer program including untested computer program code using temporal information relating to the generation of the untested computer program code. The method may include one or more computer processors retrieving a time stamp for an untested computer program code, wherein the time stamp is indicative of a time of generation of the untested computer program code. The one or more computer processors calculate, based, at least in part, on the retrieved time stamp, an accuracy risk factor for the untested computer program code. The one or more computer processors select, based, at least in part, on the calculated accuracy risk factor, a set of one or more test resources from a pool of test resources.

### BRIEF DESCRIPTION OF THE DRAWINGS

FIG. 1 is a functional block diagram illustrating a computing environment, in accordance with an embodiment of the present invention;

FIG. 2 is a flowchart depicting operational steps of a test resource selection program, on a server computer within the computing environment of FIG. 1, for generating an efficient set of tests, in accordance with an embodiment of the present invention; and

FIG. 3 depicts a block diagram of components of the server computer executing the test resource selection program within the computing environment of FIG. 1, in accordance with an embodiment of the present invention.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Embodiments of the present invention recognize that efficiency may be gained by an automated intelligent generation of an efficient set of tests for a computer program comprising untested computer program code that delivers sufficient test coverage for the untested computer program code.

Embodiments of the present invention are based on the insight that temporal information associated with generation of previously untested computer program code can be used to assess the risk that such previously untested computer program code contains one or more errors. In particular, evaluation of the day and/or the time of day at which a particular piece of computer program code is generated, can provide a good indication of the risk of the presence of such errors in the previously untested computer program code.

In some embodiments, a timestamp comprising the day and/or the time of day at which the previously untested computer program code is generated, that is, saved in a database from which an executable computer program may be built, may be used to identify potentially risky circumstances under which the computer program code was generated. In this context, potentially risky circumstances are circumstances that increase the risk that a software developer may have rushed the development of the previously untested computer program code or may have been distracted when developing the previously untested computer program code.

Example embodiments of such potentially risky circumstances include the generation of the computer program code on a day where the developer of the code had to dedicate significant amounts of time to other activities, e.g., scheduled meetings, the lateness of the time of day the developer generated the computer program code, which may be indicative of an increased level of fatigue of the developer, thus indicating an increased risk of erroneous code, a closeness of the timestamp to a particular event such as a delivery deadline for the computer program code, a scheduled period of time away from work for the developer, such as closeness of the timestamp to a weekend or a holiday of the developer, and so on.

In an embodiment, the evaluation of such a timestamp to determine an accuracy risk factor for the developed software code may involve accessing a calendar database containing calendar records for the various developers of the computer software code in order to access an electronic calendar entry of the developer of the untested computer program code relevant to the retrieved time stamp in order to estimate a risk of distraction or fatigue of the developer during generation of the untested computer program code. This for instance may comprise evaluating the various busy times in the electronic calendar entry to determine the amount of time dedicated by the developer to activities other than generation of the previously untested computer software code.

In an embodiment, calculating an accuracy risk factor for the untested computer program code based on the determined time stamp may comprise determining a reference point in time and calculating the accuracy risk factor for the untested computer program code based on a distance between the retrieved time stamp and the determined reference point in time. Such a reference point in time may be time off work for the developer, a delivery deadline for the untested computer program code developed by the developer, and more generally may be any reference point in time that may cause the developer to rush or otherwise not pay sufficient attention to the development of the untested computer program code. The calculation of the accuracy risk factor based on such a distance may for instance involve comparing a calculated distance, e.g., an amount of time between the timestamp and the reference point in time, with one or more predefined threshold distances and assigning an accuracy risk factor to the untested computer program code based on this comparison.

In an embodiment, calculating an accuracy risk factor for the untested computer program code based on the retrieved time stamp may further include accessing a database storing accuracy identifiers for historical computer program code developed by one or more developers; retrieving an accuracy identifier for historical computer program code developed by the developer of the untested computer program code; and calculating the accuracy risk factor for the untested computer program code based on the retrieved time stamp and the retrieved accuracy identifier. For example, an indication of the level of experience of the developer or the quality of the computer program code developed by the developer may be retrieved from such a historical database, and the indication may be combined with the timestamp information in order to produce a particularly relevant accuracy risk factor for the computer program code to be tested. For example, the timestamp information may be used as a scaling factor of the competence levels of the developer established from the information retrieved from the historical database.

Such a historical database may further store a plurality of historical accuracy identifiers for historical computer program code developed by each developer, each of said accuracy identifiers being associated with a historical time stamp indicative of the time of generation of the historical computer program code. This for instance may facilitate the retrieval of one or more accuracy identifiers from the plurality of historical accuracy identifiers for historical computer program code developed by the developer of the untested computer program code that have a historical time stamp corresponding to the time stamp for the untested computer program code. This may give an indication of a typical accuracy of computer program code generated by the developer under certain time constraints. For example, the historical database may indicate that a particular developer working late still produces accurate computer program code, whereas for a particular developer working close to a certain deadline, such as a delivery deadline for the computer program code or time off, e.g., weekend or holiday, accuracy of the generated computer program code diminishes. Such historical information may be used as contextual information for the timestamp associated with the untested computer program code generated by a particular developer and as such may be used to accurately determine an accuracy risk factor associated with the generated untested computer program code.

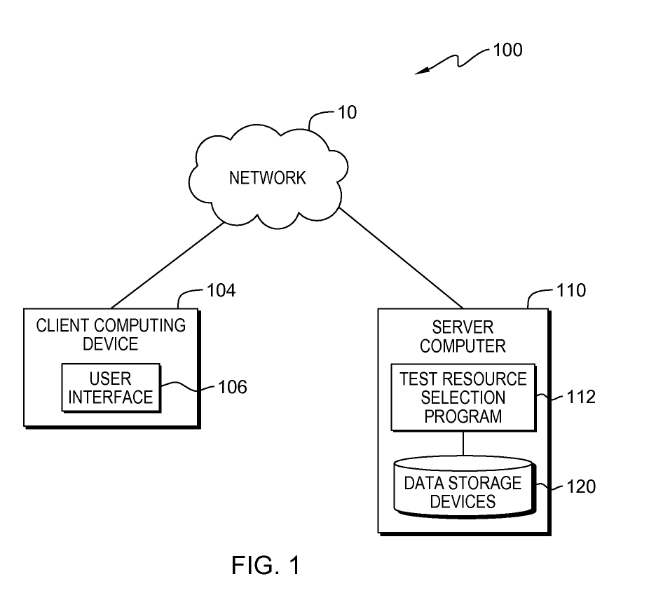

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 includes client computing device 104 and server computer 110, interconnected over network 10. Network 10 can be, for example, a telecommunications network, a local area network (LAN), a wide area network (WAN), such as the Internet, or a combination of the three, and can include wired, wireless, or fiber optic connections. Network 10 can include one or more wired and/or wireless networks that are capable of receiving and transmitting data, voice, and/or video signals, including multimedia signals that include voice, data, and video information. In general, network 10 can be any combination of connections and protocols that will support communications between client computing device 104, server computer 110, and other computing devices (not shown) within computing environment 100.

Client computing device 104 can be a laptop computer, a tablet computer, a smart phone, or any programmable electronic device capable of communicating with various components and devices within computing environment 100, via network 10. In an embodiment, client computing device 104 is capable of providing a user with the ability to perform software program development and testing activities. Client computing device 104 can be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In general, client computing device 104 represents any programmable electronic device or combination of programmable electronic devices capable of executing machine readable program instructions and communicating with other computing devices (not shown) within computing environment 100 via a network, such as network 10. Client computing device 104 includes user interface 106.

User interface 106 provides an interface between a user of client computing device 104 and server computer 110. In one embodiment, user interface 106 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 may also be mobile application software that provides an interface between a user of client computing device 104 and server computer 110. Mobile application software, or an “app,” is a computer program designed to run on smart phones, tablet computers and other mobile devices. User interface 106 enables client computing device 104 to provide access to server computer 110 for software development and testing activities.

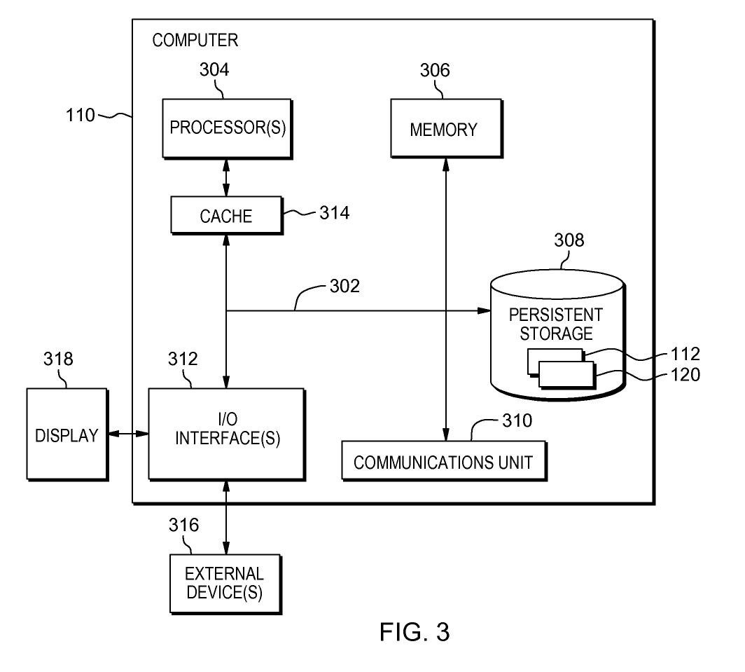

Server computer 110 can be a standalone computing device, a management server, a web server, a mobile computing device, or any other electronic device or computing system capable of receiving, sending, and processing data. In other embodiments, server computer 110 can represent a server computing system utilizing multiple computers as a server system, such as in a cloud computing environment. In another embodiment, server computer 110 can be a laptop computer, a tablet computer, a netbook computer, a personal computer (PC), a desktop computer, a personal digital assistant (PDA), a smart phone, or any programmable electronic device capable of communicating with client computing device 104 and other computing devices (not shown) within computing environment 100 via network 10. In another embodiment, server computer 110 represents a computing system utilizing clustered computers and components (e.g., database server computers, application server computers, etc.) that act as a single pool of seamless resources when accessed within computing environment 100, which may be spatially clustered, e.g., within a single computer housing, within a server rack, within a plurality of adjacent server racks in a space such as a data center, and so on, or may be spatially distributed. Server computer 110 includes test resource selection program 112 and data storage devices 120. Server computer 110 may include internal and external hardware components, as depicted and described in further detail with respect to FIG. 3.

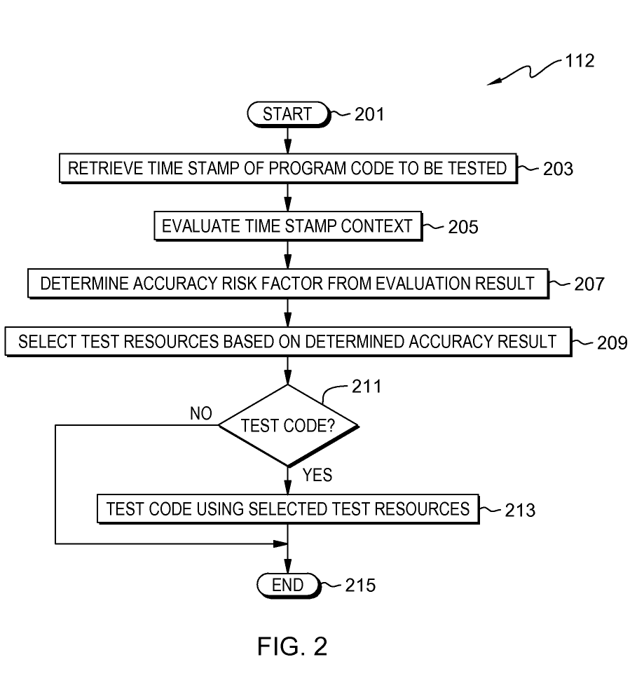

Test resource selection program 112 generates a set of test resources for testing untested computer program code in an intelligent manner using timestamp information and evaluating the timestamp information in various contexts to achieve a compact set of test resources that nevertheless have a good likelihood of producing accurate test results for the untested computer program code, thereby facilitating both efficient and accurate computer program code testing. Test resource selection program 112 is depicted and described in further detail with respect to FIG. 2.

The one or more data storage devices 120 may store a number of databases for access by server computer 110. In an embodiment, the one or more data storage devices 120 may store a computer program development database such as a content management system comprising computer programs under development, which may include some form of version and ownership control. In particular, the respective database entries may be labelled to identify a creator of the database entry, i.e., a software developer, and a timestamp identifying the time of creation of the database entry. Such a timestamp for instance may identify the time and/or date at which a particular portion of computer program code was generated by a creator identified by the creator label. The creator label and the timestamp may be different labels or may be different fields within a single label, e.g., database record metadata.

In an embodiment, the one or more data storage devices 120 may store a calendar database comprising calendar information of the various creators, i.e., software developers, of the computer program code in the aforementioned computer program development database. Such a calendar database in some embodiments may comprise a database of email accounts of the software developers, with each email account comprising a calendar section for scheduling meetings, appointments, holidays, and so on.

In an embodiment, the one or more data storage devices 120 may store a historical database in which previously developed computer program code by the respective software developers is categorized and labelled, with the labels indicating historical test results of the previously developed computer program code by the software developers. This may include a historical timestamp for the previously developed computer program code to facilitate comparison between the historical timestamp and the actual timestamp of untested computer program code for which a suitable set of tests is to be determined by test resource selection program 112. The historical database may be a separate database to the computer program development database or may form part of the computer program development database.

In an embodiment, the one or more data storage devices 120 may store a computer program test database in which a plurality of tests or test sets are defined. Each test or test set may be labelled with a particular risk factor, e.g., low, medium, high, or any other suitable categorization of risk factors indicative of the risk that untested computer program code contains an error. The computer program test database may be separate to the computer program development database or may form part of the computer program development database.

FIG. 2 is a flowchart depicting operational steps of test resource selection program 112, on server computer 110 within computing environment 100 of FIG. 1, for generating an efficient set of tests, in accordance with an embodiment of the present invention.

Test resource selection program 112 commences in step 201, for example when receiving a request to build an executable of a computer program source code developed by one or more software developers. Such computer program source code may be stored in a database such as the computer program development database included in data storage devices 120 and may include previously untested computer program source code. The previously untested computer program source code may be highlighted in the computer program source code in any suitable manner; for example, the database such as the computer program development database may employ some form of version control from which it is apparent which part of the computer program code has been altered or added to a previous known good version of the computer program, i.e., a previously tested computer program. Other suitable ways of labelling or otherwise identifying previously untested computer program source code in computer program source code to be compiled into an executable computer program will be immediately apparent to one skilled in the art.

Test resource selection program 112 may retrieve the timestamps associated with the untested computer program source code from the database such as the computer program development database in step 203. In step 205, test resource selection program 112 may evaluate the retrieved timestamps by evaluating contextual information available to test resource selection program 112. Such contextual information may include, for example, evaluating the likelihood of a low concentration level of the developer during the generation of the untested computer program code, for example because of distractions, time pressure or fatigue.

To this end, test resource selection program 112 may access a calendar database included in data storage devices 120 in which calendar entries of the various developers are kept, and retrieve one or more relevant calendar records of the developer of the untested computer program code such as a calendar record of the day on which the developer stored the untested computer program code in the computer program development database and optionally calendar records of the previous and/or next few days to determine the likelihood of diminished concentration of the developer during the development of the untested computer program code. Indications of such a diminished concentration for instance may include limited time available to generate the untested computer program code as indicated by a large number of meetings or other events immediately prior to the generation of the untested computer program code, an imminent delivery deadline for the untested computer program code, or an imminent period of leave of the developer of the computer program code, which all may be indicative of the developer not paying sufficient attention to the generation of the untested computer program code.

Alternatively or additionally, test resource selection program 112 may determine, e.g., retrieve, a reference point in time, such as a recorded start of a working day on which the untested computer program code was generated, a typical time of an end of a working day, a project delivery deadline, a starting point of annual leave, national holiday, weekend and so on. For example, test resource selection program 112 may retrieve such a reference point in time from the calendar database, the computer program development database, or from any other suitable data source. In an embodiment, the reference point in time may be user-provided. Test resource selection program 112 may be adapted to calculate a distance between the reference point in time and the timestamp associated with the untested computer program code, and the distance may be indicative of the likely accuracy of the untested computer program code. For example, where the actual timestamp of the untested computer program code is earlier in time than the reference point in time, a small distance, i.e., a small time gap between the reference point in time and the actual timestamp, may be indicative of the developer rushing to complete the untested computer program code, whereas where the actual timestamp of the untested program code is later in time than the reference point in time, a large distance, i.e., a large time gap, between the reference point in time and the actual timestamp may be indicative of the developer losing concentration, for example if the reference point in time is a typical time at which developers leave work.

In a preferred embodiment, test resource selection program 112, may retrieve further contextual information for the timestamp of the untested computer program code from a historical database included in data storage devices 120 containing accuracy identifiers for historical computer program code developed by developers. Test resource selection program 112 may be adapted to determine the general competence of the developer of the untested computer program code from these accuracy identifiers, which may be used to scale an accuracy risk factor to be determined. For example, the calendar information of the developer may indicate an increased risk of an erroneous untested computer program code, but the accuracy identifiers retrieved from the historical database indicate that the developer typically generates high-quality computer program code.

In an embodiment, test resource selection program 112 may rank the competence of each developer, e.g., test resource selection program 112 may assign a competence score based on historical performance, and test resource selection program 112 may adjust the competence score based on the timestamp evaluation of the timestamp associated with the untested computer program code developed by the developer. For example, test resource selection program 112 may decrease the competence score if there is reason to assume that there is an increased risk of the introduction of errors in the untested computer program code generated by the developer, as previously discussed.

The accuracy identifiers in the historical database may be associated with historical timestamps, that is the date and/or time at which the historical computer program code was generated. Test resource selection program 112 may search a historical database for historical computer program code generations by the developer of the untested computer program code to identify historical computer program code generations at similar points in time to the untested computer program code, for example at a similar point during the day, e.g., late at night, shortly before the weekend or a holiday, close to a delivery deadline of the computer program code, and so on, such that the accuracy identifier for the historical computer program code associated with such a comparable historical timestamp can be used as the accuracy risk factor for the untested computer program code, because the historical data provides evidence of the ability of the developer to produce computer program code of a certain standard under certain conditions.

In step 207, test resource selection program 112 determines an accuracy risk factor based on the evaluation of the timestamp of the untested computer program code, the evaluation of the relevant calendar database entries, and optionally the evaluation of the relevant historical database entries relating to historical computer program code developed by the developer. The accuracy risk factor may be, for example, a classification from a set of classifications, e.g., low risk, medium risk, high risk. The accuracy risk factor may also be a risk score on a numerical scale, such as a scale from 1-5, 1-10 and so on, or the accuracy risk factor may employ any other suitable classification system. It will be immediately apparent to one skilled in the art that a large number of suitable classification systems for such accuracy risk factors may be used, and it is stated for the sake of brevity that any suitable classification system may be employed.

Test resource selection program 112 uses the accuracy risk factor determined in step 207 in step 209 to select the test resources to use for testing the untested computer program code of the developer. For example, test resource selection program 112 may have access to a computer program test database included in data storage devices 120 that includes a pool of test resources such as test programs and test platforms, wherein the test resources may be labelled with an accuracy risk factor threshold in order to determine if the test resource should be included in the set of test resources to be used for testing the untested computer program code of the developer. Test resource selection program 112 may compare the determined accuracy risk factor of the untested computer program code with the accuracy risk factor thresholds of the respective test resources and may include the test resource in the set of test resources to be used for testing the untested computer program code if the accuracy risk factor of the untested computer program code meets or exceeds an accuracy risk factor threshold of the test resource. In this manner, test resource selection program 112 can automatically compile a set of test resources to use for testing the untested computer program code based on the accuracy risk factor determined for the untested computer program code.

Alternatively, the computer program test database may contain predetermined sets of test resources with each predetermined set associated with a particular accuracy risk factor such that test resource selection program 112 may simply select the appropriate set of predetermined test resources based on the accuracy risk factor determined for the untested computer program code.

It should be understood that the above embodiments of selecting test resources based on the determined accuracy risk factor are exemplary embodiments only and that alternative approaches for selecting test resources based on such a determined accuracy risk factor may be employed. Such alternative approaches will be readily available to the skilled person.

In an embodiment, test resource selection program 112 may further determine, in decision block 211, if the untested computer program code should be tested using the set of test resources selected in step 209. If test resource selection program 112 determines the untested computer program code should be tested (“yes” branch, decision block 211), then test resource selection program 112 tests the untested computer program code in step 213 using the selected test resources before terminating in step 215. If test resource selection program 112 determines the untested computer program code should not be tested (“no” branch, decision block 211), then test resource selection program 112 may terminate directly in step 215 without testing the untested computer program code. When testing the untested computer program code in step 213, test resource selection program 112 may further generate output indicative of the test result on one or more output devices communicatively coupled to server computer 110 of computing environment 100.

FIG. 3 depicts a block diagram of components of server computer 110 within computing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 110 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., test resource selection program 112 and data storage devices 120 are stored in persistent storage 308 for execution and/or access by one or more of the respective processor(s) 304 of server computer 110 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 104. In these examples, communications unit 310 includes one or more network interface cards. Communications unit 310 may provide communications through the use of either or both physical and wireless communications links. Test resource selection program 112 and data storage devices 120 may be downloaded to persistent storage 308 of server computer 110 through communications unit 310.

I/O interface(s) 312 allows for input and output of data with other devices that may be connected to server computer 110. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., test resource selection program 112 and data storage devices 120 on server computer 110, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for selecting a set of test resources for testing a computer program including untested computer program code, the method comprising:
retrieving, by one or more computer processors, a time stamp for an untested computer program code, wherein the time stamp is indicative of a time of generation of the untested computer program code;
calculating, by the one or more computer processors, based, at least in part, on the retrieved time stamp, an accuracy risk factor for the untested computer program code; and
selecting, by the one or more computer processors, based, at least in part, on the calculated accuracy risk factor, a set of one or more test resources from a pool of test resources.

2. The method of claim 1, wherein calculating the accuracy risk factor for the untested computer program code further comprises:
accessing, by the one or more computer processors, an electronic calendar entry of a developer of the untested computer program code, wherein the electronic calendar entry is related to the retrieved time stamp; and
estimating, by the one or more computer processor, a risk of distraction of the developer during a time of generation of the untested computer program code.

3. The method of claim 1, wherein calculating the accuracy risk factor for the untested computer program code further comprises:
determining, by the one or more computer processors, a reference point in time; and
calculating, by the one or more computer processors, based, at least in part, on a distance between the retrieved time stamp and the determined reference point in time, the accuracy risk factor for the untested computer program code.

4. The method of claim 3, wherein the reference point in time is at least one of: a recorded start of a working day on which the untested computer program code was generated, a typical time of an end of a working day, a starting point of a leave of one or more developers of the untested computer program code, and a delivery deadline for a computer program including untested computer program code.

5. The method of claim 1, wherein calculating the accuracy risk factor for the untested computer program code further comprises:
accessing, by the one or more computer processors, a database storing one or more accuracy identifiers for historical computer program code developed by one or more developers;
retrieving, by the one or more computer processors, an accuracy identifier for the historical computer program code developed by the one or more developers of the untested computer program code; and
calculating, by the one or more computer processors, based, at least in part, on the retrieved time stamp and the retrieved accuracy identifier, the accuracy risk factor for the untested computer program code.

6. The method of claim 5, wherein:
the database storing one or more accuracy identifiers for historical computer program code developed by one or more developers stores a plurality of historical accuracy identifiers for historical computer program code developed by each of the one or more developers, each of the one or more accuracy identifiers being associated with a historical time stamp indicative of the time of generation of the historical computer program code; and
retrieving an accuracy identifier for historical computer program code developed by the developer of the untested computer program code further comprises retrieving, by the one or more computer processors, one or more accuracy identifiers from the plurality of historical accuracy identifiers for historical computer program code developed by the one or more developers of the untested computer program code that has a historical time stamp corresponding to the retrieved time stamp for the untested computer program code.

7. The method of claim 1, wherein the retrieved time stamp specifies at least one of: a date or a time of day.

8. The method of claim 1, further comprising, prior to retrieving a time stamp for the untested computer program code indicative of a time of generation of the untested computer program code, receiving, by the one or more computer processors, a build request of a computer program.

9. The method of claim 1, wherein the pool of test resources includes a plurality of computer program tests and a plurality of hardware platforms on which a computer program can be tested.

10. The method of claim 1, further comprising:
testing, by the one or more computer processor, with the selected test resources, a computer program including untested computer program code; and
generating, by the one or more computer processors, a test result for the tested computer program.

11. A computer program product for selecting a set of test resources for testing a computer program including untested computer program code, the computer program product comprising:
one or more computer readable storage device and program instructions stored on the one or more computer readable storage device, the stored program instructions comprising:
program instructions to retrieve a time stamp for an untested computer program code, wherein the time stamp is indicative of a time of generation of the untested computer program code;
program instructions to calculate, based, at least in part, on the retrieved time stamp, an accuracy risk factor for the untested computer program code; and
program instructions to select, based, at least in part, on the calculated accuracy risk factor, a set of one or more test resources from a pool of test resources.

12. The computer program product of claim 11, wherein the program instructions to calculate the accuracy risk factor for the untested computer program code comprise:
program instructions to access an electronic calendar entry of a developer of the untested computer program code, wherein the electronic calendar entry is related to the retrieved time stamp; and
program instructions to estimate a risk of distraction of the developer during a time of generation of the untested computer program code.

13. The computer program product of claim 11, wherein the program instructions to calculate the accuracy risk factor for the untested computer program code comprise:
program instructions to determine a reference point in time; and
program instructions to calculate, based, at least in part, on a distance between the retrieved time stamp and the determined reference point in time, the accuracy risk factor for the untested computer program code.

14. The computer program product of claim 13, wherein the reference point in time is at least one of: a recorded start of a working day on which the untested computer program code was generated, a typical time of an end of a working day, a starting point of a leave of one or more developers of the untested computer program code, and a delivery deadline for a computer program including untested computer program code.

15. The computer program product of claim 11, wherein the program instructions to calculate the accuracy risk factor for the untested computer program code comprise:
program instructions to access a database storing one or more accuracy identifiers for historical computer program code developed by one or more developers;
program instructions to retrieve an accuracy identifier for the historical computer program code developed by the one or more developers of the untested computer program code; and
program instructions to calculate, based, at least in part, on the retrieved time stamp and the retrieved accuracy identifier, the accuracy risk factor for the untested computer program code.

16. A computer system for selecting a set of test resources for testing a computer program including untested computer program code, the computer system comprising:
one or more computer processors;
one or more computer readable storage device;
program instructions stored on the one or more computer readable storage device for execution by at least one of the one or more computer processors, the stored program instructions comprising:
program instructions to retrieve a time stamp for an untested computer program code, wherein the time stamp is indicative of a time of generation of the untested computer program code;
program instructions to calculate, based, at least in part, on the retrieved time stamp, an accuracy risk factor for the untested computer program code; and
program instructions to select, based, at least in part, on the calculated accuracy risk factor, a set of one or more test resources from a pool of test resources.

17. The computer system of claim 16, wherein the program instructions to calculate the accuracy risk factor for the untested computer program code comprise:
program instructions to access an electronic calendar entry of a developer of the untested computer program code, wherein the electronic calendar entry is related to the retrieved time stamp; and
program instructions to estimate a risk of distraction of the developer during a time of generation of the untested computer program code.

18. The computer system of claim 16, wherein the program instructions to calculate the accuracy risk factor for the untested computer program code comprise:
program instructions to determine a reference point in time; and
program instructions to calculate, based, at least in part, on a distance between the retrieved time stamp and the determined reference point in time, the accuracy risk factor for the untested computer program code.

19. The computer system of claim 18, wherein the reference point in time is at least one of: a recorded start of a working day on which the untested computer program code was generated, a typical time of an end of a working day, a starting point of a leave of one or more developers of the untested computer program code, and a delivery deadline for a computer program including untested computer program code.

20. The computer system of claim 16, wherein the program instructions to calculate the accuracy risk factor for the untested computer program code comprise:
program instructions to access a database storing one or more accuracy identifiers for historical computer program code developed by one or more developers;
program instructions to retrieve an accuracy identifier for the historical computer program code developed by the one or more developers of the untested computer program code; and
program instructions to calculate, based, at least in part, on the retrieved time stamp and the retrieved accuracy identifier, the accuracy risk factor for the untested computer program code.
